(19) United States
(12) Patent Application Publication
(10) Pub. No.: US 2004/0230789 A1
(43) Pub. Date: Nov. 18, 2004

(54) Multi memory card accessing system and implementation method thereof

(76) Inventor: Pu-Yun Lee, Taipei (TW)

Correspondence Address: HARNESS, DICKEY & PIERCE, P.L.C., P.O. BOX 8910, RESTON, VA, 20195, US

(21) Appl. No.: 10/438,931

(22) Filed: May 16, 2003

(51) Int. Cl. G06F 9/445

(52) U.S. Cl. 713/2

(57) ABSTRACT

A memory card accessing system boots a computer host by means of a memory card reader that loads and reads different types of memory card. The memory card accessing system includes a multi-type memory card reader and a computer host. The memory card accessing system detects if any booting application exists on one of the memory cards on the memory card reader. If a system firmware has set the booting operation to the memory card reader, and the reader firmware has detected the presence of a booting application on one of the memory cards, the corresponding memory card is identified as a logic disk for the memory card reader to boot the computer.

### BACKGROUND OF THE INVENTION

1. Field of Invention

The present invention relates to a memory card accessing system and an implementation method thereof. More particularly, the invention relates to a memory card accessing system that uses a multi-type memory card reader to read different types of memory cards to boot a computer host, and an implementation method thereof.

2. Related Art

Memory cards are increasingly used as information recording media, and even may progressively replace floppy disks and compact disks. For example, portable devices such as digital cameras, digital video cameras, MP3 players, personal digital assistants (PDA) and cell phones use memory cards for storing information or image data. Currently, the commercially available memory cards include compact flash (CF) cards, smart media (SM) cards, secure digital (SD) cards, micro drive (MD) cards, memory stick (MS) cards, and multimedia cards (MMC). The information stored in the memory card is usually accessed by a memory card reader, and is then transmitted to a host.

It is convenient for the user to boot a computer via the memory card reader if the peripheral device of the computer does not have a booting application. However, the commercially available memory card reader is not provided with a booting function. One memory card reader that is capable of reading different types of memory cards and booting the host through a single memory card, for example, a CF card, is known in the prior art. However, if the CF card does not contain any booting application, the memory card reader cannot boot the host, even if another type of loaded memory card such as, for example, the SD card, is provided with the booting application.

Therefore, there is a need of a multi-type memory card reader that is capable of booting the computer host from any memory card that is loaded with a booting application.

### SUMMARY OF THE INVENTION

The purpose of the invention is, therefore, to provide a multi-type memory card accessing system and an implementation method thereof. When the memory card reader detects that one memory card in the memory card reader is loaded with a booting application, the system firmware of the computer host loads the booting application from the corresponding memory card to boot the computer host.

In order to achieve the mentioned and other objectives, the invention provides a multi-type memory card accessing system that boots the computer host. The memory card accessing system includes a computer host and a multi-type memory card reader that is capable of reading different types of memory cards. In an implementation method, if the booting operation is assigned to the multi-type memory card reader, the memory card reader detects which memory card is loaded with a booting application and sets the corresponding memory card as a logic disk of the memory card reader to boot the host.

As described above, the memory card reader detects which memory card is loaded with the booting application and selects that memory card as the logic disk of memory card reader if a system firmware has assigned the booting task to the multi-type memory card reader.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent from this detailed description to those skilled in the art.

### BRIEF DESCRIPTION OF THE DRAWINGS

The present invention will become more fully understood from the detailed description in the given illustration hereafter, which is provided only for illustration purpose and thus should not be construed in a manner to limit the scope of the present invention. In the drawings:

FIG. 1 is a schematic view of a memory card accessing system that boots a host via a multi-type memory card reader according to one embodiment of the invention; and

FIG. 2 is a flow chart illustrating an implementation method of a memory card accessing system that boots a host via a multi-type memory card reader according to one embodiment of the invention.

### DETAILED DESCRIPTION OF THE INVENTION

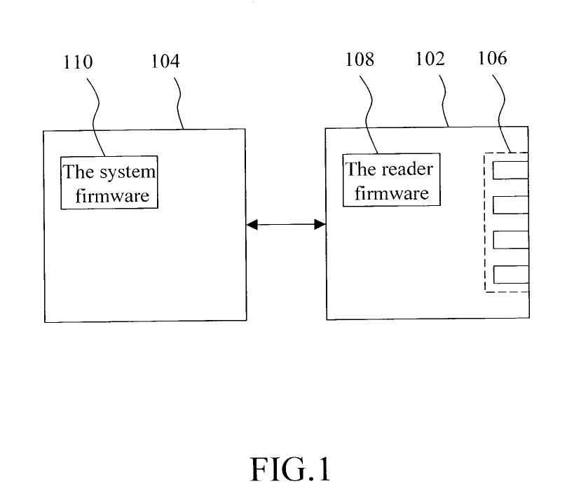

FIG. 1 is a schematic view of a memory card accessing system that can boot a computer host via a memory card reader, compatible with different types of memory cards (hereafter described as ‘multi-type memory card reader’), according to one embodiment of the invention. Referring to FIG. 1, a memory card accessing system 10 includes a multi-type memory card reader 102 and a computer host 104. The multi-type memory card reader 102 includes a plurality of slots 106 and a memory card reader firmware 108. The host 104 includes a system firmware 110. The functions of the memory card accessing system 10 are described hereafter.

The slots 106 respectively receive different types of memory cards such as compact flash (CF) cards, smart media (SM) cards, secure digital (SD) cards, micro drive (MD) cards, memory stick (MS) cards, and multimedia cards (MMC). The memory card reader firmware 108 detects which memory card is loaded with a booting application in a predetermined sequence. The system firmware 110 determines whether the host is booted via the multi-type memory card reader 102. When the system firmware assigns the booting operation to the memory card reader 102, the memory card reader firmware 108 detects whether at least one memory card is loaded with the booting application. If so, the memory card is appointed as a logic disk of the multi-type memory card reader and the system firmware 110 boots the host 104 from that memory card. When the system firmware 110 does not assign the booting operation to the multi-type memory card reader 102, or when the reader firmware 108 does not detect the presence of any memory cards loaded with the booting application, the system firmware 110 then boots the host 104 via one peripheral device that is loaded with the booting application.

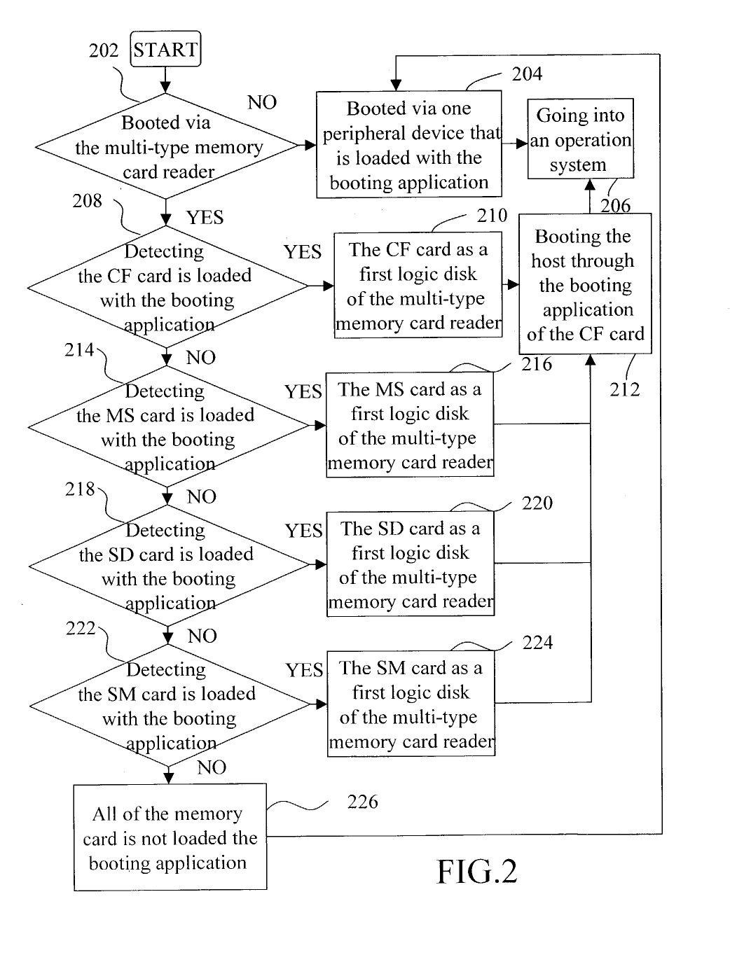

FIG. 2 is a flow chart illustrating a method of implementing a memory card accessing system that can boot a host via a multi-type memory card reader according to one embodiment of the invention. In FIG. 2, it is assumed that a CF card, a MS card, a SD card and a SM card are inserted in the multi-type memory card reader 102, and the detecting sequence set in the reader firmware 108 applies to the CF card, the MS card, the SD card and the SM card. An implementation of the memory card accessing system, capable of booting a host via a multi-type memory card reader according to the invention, now is described with reference to FIG. 1 and FIG. 2.

The system firmware 110 determines whether the host 104 is booted via the multi-type memory card reader 102 (step S202). When the system firmware 110 does not assign the booting operation to the multi-type memory card reader 102, the system firmware 110 boots the host 104 via one peripheral device that is loaded with the booting application (step S204). When the host 104 has successfully booted, it goes into an operation system (step 206).

When the system firmware 110 assigns the booting operation to the multi-type memory card reader 102, the reader firmware 108 detects whether the CF card is loaded with the booting application (step S208). If the CF card is loaded with the booting application, the reader firmware 108 appoints the CF card as a first logic disk of the multi-type memory card reader 102 (step S210). Then, the system firmware 110 boots the host through the booting application of the CF card (step S212).

If the reader firmware 108 detects that the CD card is not loaded with the booting application, the reader firmware 108 sequentially detects whether the MS card is loaded with the booting application (step S214). If the MS card is loaded with the booting application, the reader firmware 108 then appoints the MS card as the first logic disk of the multi-type memory card reader 102 (step S216). Then, the system firmware 110 boots the host through the booting application of the MS card (step S214).

If the reader firmware 108 detects that the MS card is not loaded with the booting application, the reader firmware 108 sequentially detects whether the SD card is loaded with the booting application (step S218). If the SD card is loaded with the booting application, the reader firmware 108 appoints the SD card as the first logic disk of the multi-type memory card reader 102 (step S220). Then, the system firmware 110 boots the host through the booting application of the SD card (step S212).

If the reader firmware 108 detects that the SD card is not loaded with the booting application, the reader firmware 108 sequentially detects whether the SM card is loaded with the booting application (step S222). If the SM card is loaded with the booting application, the reader firmware 108 appoints the SM card as the first logic disk of a multi-type memory card reader 102 (step S224). Then, the system firmware 110 boots the host through the booting application of the SM card (step S212).

If the reader firmware 108 detects the SM card is not loaded with the booting application, the reader firmware 108 reports this result to the system firmware 110 and the control of the booting operation of the host is managed by the system firmware 110 (step 226). At this time, the system firmware 110 boots the host 104 via one peripheral device that is loaded with the booting application (step S204).

As described above, the memory card reader detects which memory card is loaded with the booting application and selects that memory card as the logic disk of the memory card reader, if a system firmware is set to boot the host via the memory card reader.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A memory card accessing system capable of booting a host via a multi-type memory reader, comprising:
a multi-type memory card reader, including:
a plurality of slots for receiving a plurality of memory cards; and
a reader firmware used to detect which memory card is loaded with a booting application; and
a computer host, comprising a system firmware, wherein if the system firmware assigns the booting operation to the multi-type memory card reader, the multi-type memory card reader detects which memory card is loaded with the booting application and sets the corresponding memory card loaded with the booting application as a logic disk of the multi-type memory card reader to boot the host.

2. The system of claim 1, wherein the reader firmware detects which memory card is loaded with a booting application according to a predetermined detecting sequence.

3. The system of claim 1, wherein if the system firmware does not assign the booting operation to the multi-type memory card reader, the system firmware boots the host via one peripheral device that is loaded with the booting application.

4. The system of claim 1, wherein if the reader firmware detects that no memory cards are loaded with the booting application, the system firmware boots the host via one peripheral device that is loaded with the booting application.

5. The system of claim 1, wherein the memory cards include a compact flash (CF) card, a smart media (SM) card, a secure digital (SD) card, a micro drive (MD) card, a memory stick (MS) card, and a multimedia card (MMC).

6. A memory card accessing system capable of booting a host via a multi-type memory card, comprising:
a multi-type memory card reader, receiving a plurality of memory cards and detecting which memory card is loaded with a booting application; and
a computer host, comprising a system firmware, wherein if the system firmware assigns the booting operation to the multi-type memory card reader, the multi-type memory card reader detects which memory card is loaded with the booting application and sets the corresponding memory card as a logic disk of the multi-type memory card reader to boot the host.

7. The system of claim 6, wherein if the system firmware does not assign the booting operation to the multi-type memory card reader, the system firmware boots the host via one peripheral device that is loaded with the booting application.

8. The system of claim 6, wherein if no memory cards have the booting application, the system firmware boots the host via one peripheral device that is loaded with the booting application.

9. The system of claim 6, wherein the memory cards include a compact flash (CF) card, a smart media (SM) card, a secure digital (SD) card, a micro drive (MD) card, a memory stick (MS) card, and a multimedia card (MMC).

10. A method of implementing a memory card accessing system capable of booting a host via a multi-type memory card reader, wherein the memory card accessing system includes a computer host and a multi-type memory card reader capable of receiving different types of memory card, the method comprising:
detecting which memory card in the reader firmware is loaded with the booting application if the booting operation is assigned to the multi-type memory card reader, wherein the memory card that has the booting application is appointed as a logic disk of the multi-type memory card reader; and
booting the host through the booting application.

11. The method of claim 10, wherein if the system firmware does not assign the booting operation to the multi-type memory card reader, the system firmware boots the host via one peripheral device that is loaded with the booting application.

12. The method of claim 10, wherein if no memory cards have the booting application, the system firmware boots the host via one peripheral device that is loaded with the booting application.

13. The method of claim 10, further comprising a step of determining whether the multi-type memory card reader is used to boot the host.

14. The method of claim 10, wherein the step of detecting which memory card in the reader firmware is loaded with the booting application is achieved by a reader firmware of the multi-type memory card reader.

15. The method of claim 14, wherein the memory card reader firmware detects which memory card is loaded with a booting application according to a predetermined detecting sequence.

16. The method of claim 10, wherein the memory cards include a compact flash (CF) card, a smart media (SM) card, a secure digital (SD) card, a micro drive (MD) card, a memory stick (MS) card, and a multimedia card (MMC).
